(19) United States
(12) Patent Application Publication
(10) Pub. No.: US 2025/0200546 A1
(43) Pub. Date: Jun. 19, 2025

(54) POINT OF SALE DATA GENERATION

(71) Applicant: Dell Products L.P., Round Rock, TX (US)

(72) Inventors: Eric L. Caron, Ottawa (CA); Nalinkumar Mistry, Ottawa (CA); Vinicius Michel Gottin, Rio de Janeiro (BR); Paulo Abelha Ferreira, Rio de Janeiro (BR); Jason Bonafide, Winter Garden, FL (US)

(21) Appl. No.: 18/544,251

(22) Filed: Dec. 18, 2023

(51) Int. Cl. G06Q 20/20; G06Q 20/40

(52) U.S. Cl. CPC G06Q 20/202; G06Q 20/4016

(57) ABSTRACT

One example method includes scanning, at a point of sale (POS) site, a physical object, transmitting, from the POS site to a regional environment, information obtained as a result of the scanning of the physical object, identifying the physical object based on the information, automatically labeling any new data generated as a result of the identifying of the physical object, and storing the new data. The information obtained as a result of the scanning may be used to determine whether or not a fraudulent transaction has taken place at the POS site.

### FIELD OF THE INVENTION

Embodiments of the present invention generally relate to visual identification of physical items. More particularly, at least some embodiments of the invention relate to systems, hardware, software, computer-readable media, and methods, for identifying, and resolving, problems encountered during the scanning of physical items.

### BACKGROUND

With the massive supply of checkout automation, inventory shrinkage has been consistently called out as a major factor in increased consumer costs at grocery stores. One of the United States biggest retailers, Walmart, has highlighted shrinkage, particularly resulting from theft, as a major obstacle in keeping consumer cost low which is a focal point in their business model. For example, shrinkage due to theft can occur when a shopper scans a low cost item but actually leaves the store with a higher cost item. As another example, a shopper may place a high cost item inside a low cost item where the high cost item cannot be seen, and then scan only the low cost item at checkout. Unless the store has anti-theft tags on the items, and detectors at the exits, it may be difficult or impossible to deter this shrinkage mechanism.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an architecture and environment according to one embodiment.

FIG. 2 discloses aspects of a process flow according to one embodiment.

FIG. 3 discloses aspects of an inventory 3D modeling component according to one embodiment.

FIG. 4 discloses an example of a physical object that may be imaged, from various perspectives, by an embodiment.

FIG. 5 discloses aspects of an item scanning component according to one embodiment.

FIG. 6 discloses aspects of an example system for scanning an object, according to one embodiment.

FIG. 7 discloses aspects of another example system for scanning an object, according to one embodiment.

FIG. 8 discloses aspects of an item detection component according to one embodiment.

FIG. 9 discloses detailed aspects of the ML image inference component of FIG. 8.

FIG. 10 discloses an example approach for item detection with high probability of being known, according to one embodiment.

FIG. 11 discloses a system for performing object scanning, according to one embodiment.

FIG. 12 discloses an example of RGB-D camera 3D modeling.

FIG. 13 an approach for mesh comparison, according to one embodiment.

FIG. 14 discloses an example of a higher tolerance mesh in terms of difference/comparison.

FIG. 15 discloses an example of a lower tolerance mesh in terms of difference/comparison.

FIG. 16 discloses a manual evaluation of an image performed using a user dashboard.

FIG. 17 discloses a manual depth measurement of an image, performed using a user dashboard.

FIG. 18 discloses aspects of an item accuracy detection and training component according to one embodiment.

FIG. 19 discloses a method according to one example embodiment.

FIG. 20 discloses aspects of a computing entity configured to perform any of the disclosed methods, processes, flows, and operations.

### DETAILED DESCRIPTION OF SOME EXAMPLE EMBODIMENTS

Embodiments of the present invention generally relate to visual identification of physical items. More particularly, at least some embodiments of the invention relate to systems, hardware, software, computer-readable media, and methods, for identifying, and resolving, problems encountered during the scanning of physical items.

One example embodiment may aid the identification of inaccurate item scanning through the use of Digital Twins (DT) (see, e.g., https://en.wikipedia.org/wiki/Digital_twin) and Machine Learning (ML). With the ability to generate high-resolution 3D models using imaging and depth-sensing equipment, and the ability to compare models of inventory, an embodiment may be able to identify when inaccurate item scanning, of a physical item, is occurring, such as in retail settings for example.

In more detail, a method according to one embodiment may be implemented, at least in part, at a self-checkout kiosk, and may comprise various operations, such as: [1] inventory 3D modeling; [2] item scanning; [3] item detection; and, [4] auto labeling of the item. For [1], a repository of 3D models may be created against which a scanned item may be compared. When a customer scans [2] an item at a checkout kiosk, the information from the scan may be sent to a regional environment for detection [3], such as by comparison on one of the 3D models and/or based on an ML inference. Finally, at [4] information about the scanned item may be labeled and, if needed, may also be added to a collection of labeled data.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that inventory shrinkage of a business may be reduced relative to what the shrinkage would otherwise be expected to be in the absence of the us of the embodiment. An embodiment may operate to correctly identify scanned items. Various other advantages of one or more example embodiments will be apparent from this disclosure.

### A. Aspects of an Example Environment According to an Embodiment

The following is a discussion of aspects of example operating environments for various embodiments of the invention. This discussion is not intended to limit the scope of the invention, or the applicability of the embodiments, in any way.

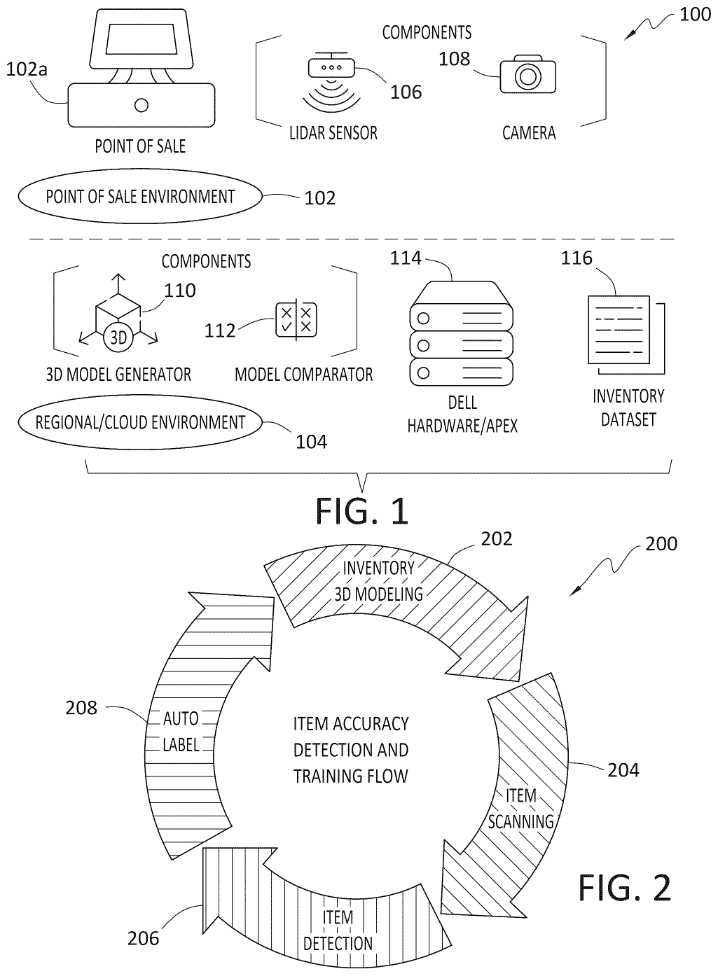

With particular attention now to FIG. 1, one example of an operating environment for embodiments of the invention is denoted generally at 100. In general, the operating environment 100 may comprise various environments including, for example, a point-of-sale (POS) environment 102, and a regional/cloud environment 104, that may communicate, and interoperate, with each other. The POS environment 102 may comprise, for example, a self-checkout kiosk 102a, and/or an environment that comprises one or more self-checkout kiosks.

As shown in FIG. 1, the POS environment 102 may comprise various types and numbers of optical systems and devices that are able to generate and/or detect optical signals. Such optical systems and devices include, but are not limited to, a LIDAR (light detection and ranging) sensor 106, and a camera 108 such as a video camera, still camera, and/or RGB-D (red-green-blue-depth) depth-sensing camera, for example. No particular types or combinations of optical devices are required in any embodiment.

In more detail, and with continued reference to the example of FIG. 1, an embodiment may comprise a multi-environment approach in which respective computing operations are performed at both edge, and regional, environments. In the example of FIG. 1, the edge environment is the area where customers purchase their items at a checkout kiosk, that is, the POS environment 102. As well, the regional/cloud environment 104 may comprise computing capabilities for detecting items, building 3D models, and enabling human interaction with mesh construction for follow-up items pertaining to item detection accuracy. An example of a follow-up item would be to flag an active transaction at a particular kiosk or to manually verify an auto-labelled item. To carry out these various functions, the regional cloud environment 104 may comprise resources such as, but not limited to, a 3D model generator 110, a model comparator 112, a computing platform 114, which may comprise DellTechnologies hardware/APEX (cloud computing) platform, for example, and an inventory dataset 116. Further details concerning the operation of the various components disclosed in FIG. 1 are disclosed below.

### B. Aspects of an Example System Flow According to an Embodiment

With attention now to FIG. 2, an example system flow according to one embodiment is denoted generally at 200. This example embodiment may comprise four different components, or processes, that may operate continuously to improve the accuracy of item detection. An embodiment may also provide a foundation for intervention regarding potentially inaccurate transactions taking place at a checkout kiosk. A brief introduction and description of the functions for each of the components shown in FIG. 2 will now be provided, with further details to be provided elsewhere herein.

The first component is an inventory 3D modeling component 202. Among other things, this component may use and/or comprise a repository of 3D models of various elements of an inventory, which may be compared with items being identified. In an embodiment, this inventory 3D modeling component 202 may also generate 3D models of inventory items.

Another component of the system flow 200 is an item scanning component 204, which may follow the inventory 3D modeling component 202, as shown in FIG. 2. In generally, the item scanning component 204 may comprise a flow that takes place at a checkout kiosk where a customer continuously scans items, and item information about those items may be sent to a regional environment, such as the regional/cloud environment 104 for example, for identification of the scanned items.

With continued attention to the example of FIG. 2, the system flow 200 may comprise an item detection component 206, which may follow the item scanning component 204. In general, the item detection component 206 may use, as input, data received from the item scanning component 204 to detect which item was scanned. This determination may be made, for example, using ML inferencing, and/or may be based on 3D models.

Finally, the example system flow 200 may comprise an auto label component 208, which may follow the item detection component 206. In general, the auto label component 208 may operate to add newly scanned item information and inference information to a collection of labelled data.

### B.1 Inventory 3D Modeling

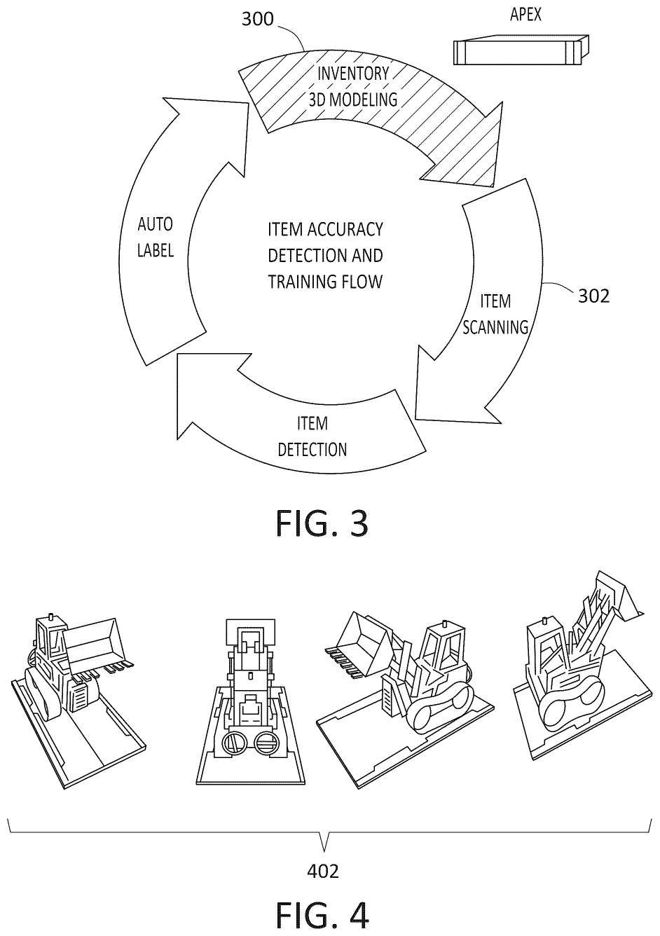

With attention now to FIG. 3, further details are provided concerning an example inventory 3D modeling component 300. In order to detect/verify what item is being scanned, an embodiment may employ a set of data to compare scanned items against. In this regard, one embodiment may assume that one or the other of the following scenarios should be true: [1] pre-trained dataset of the inventory exists; or [2] a pre-cursor to this flow is that 3D models, such as CAD (computer aided design) models for example, have been built for inventory items.

Assuming, for example, that [1] is true, the next operation in a flow according to one example embodiment is to move to an item scanning component 302. In an embodiment, each item in the pre-trained dataset of the inventory may comprise any combination of one or more of the following: [a] item type; [b] item brand; [c] item price; [d] item size; and [e] an item-unique bar code.

With reference now to the scenario [2] immediately above, and turning next to the example of FIG. 4, in the case where there does not exist a pre-trained dataset, scenario [1] above, and 3D models of the existing inventory are needed to serve as identifying models, each item may be captured, such as by an optical device, at various different angles. FIG. 4 discloses an example where images 402 of a toy tractor have been generated, such as by one of the optical devices disclosed herein, at various different perspectives relative to the toy tractor. In an embodiment, these images may be used as input into an inventory identifier dataset.

In particular, FIG. 4 discloses an example item, namely, a physical product in the form of a toy tractor, that is an inventory item. Capturing images and creating 3D models from a large inventory set of items may be time, and resource, intensive and, as such, an embodiment may implement image capture and 3D model generation as a long-running, or ongoing, operation in which this data is collected over a period of time, possibly in an automated manner. One embodiment may deal with this circumstance through the use of the disclosed item detection and auto labelling components. As discussed below, an embodiment may comprise a system flow in which scanned item information is captured and persisted within one or more existing datasets.

It is noted that different operational environments for embodiments may be composed of different respective computing capability composition and, as such, an embodiment may employ a size characteristic for models. For example, sizes may include small, medium, and large. A ‘small’ size, for example, may apply to an edge environment where computing capabilities may be relatively limited.

One embodiment may be configured to run in what may be referred to herein as an observation mode, that is, a mode where the embodiment is used solely for data capture from components such as Item Scanning (see, e.g., 204 in FIG. 2) through auto labeling (see, e.g., 208 in FIG. 2). In this mode, an embodiment may create an input dataset required for the entire system to operate at full function, that is, all four of the components in the example flow 200.

One challenge that may be addressed by an embodiment is that using scanned item images, video and data, is that different hands, holding the item during a scan of the item, may vary in terms of their respective shape, size color, and various characteristics. While this problem might be addressed by acquiring each item in the inventory dataset with multiple combinations of hand variations, such as positions, shapes, sizes and color, such an approach may be too costly and not feasible in practice.

Thus, an embodiment may comprise an approach in which a separate model is obtained to perform targeted object detection-for example, to detect hands. This model, which could be separately trained or acquired, could then be used to isolate the parts of the detection that pertain to the item-such as by segmenting or cropping the capture, for example. Thus, an embodiment may assume that the current state-of-the-art of object detection models may be used, and that an appropriate segmenting or cropping strategy based on hand detection can be applied.

### B.2 Item Scanning

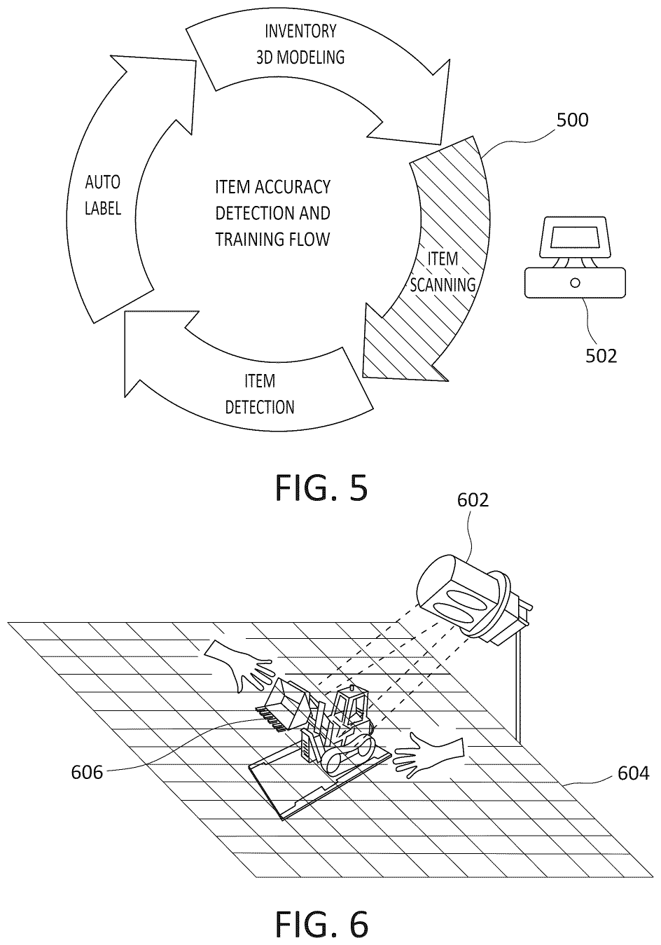

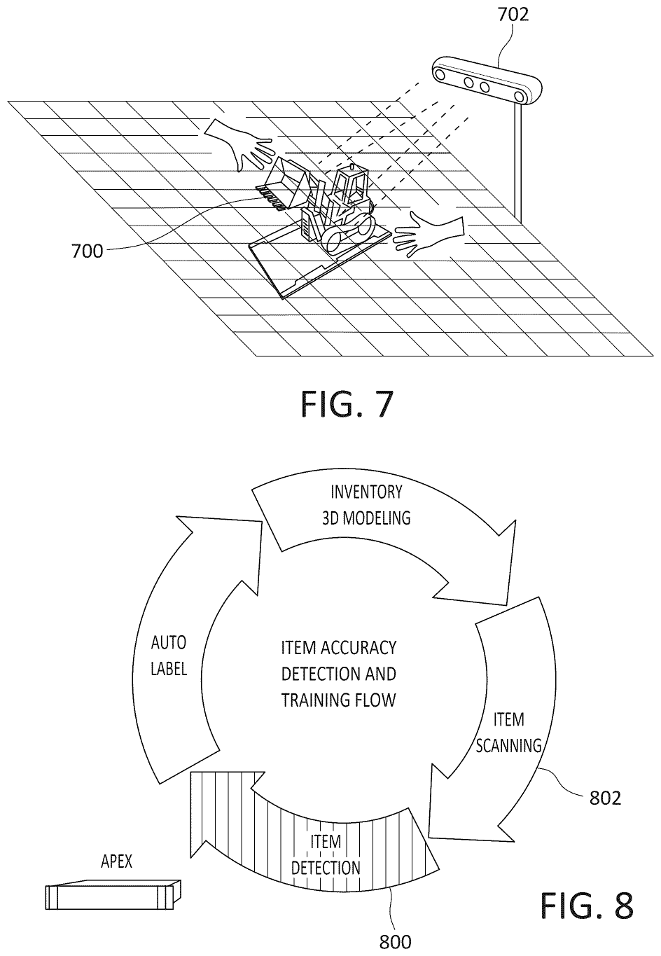

With reference next to the example of FIG. 5, further details are provided concerning an item scanning component 500, such as may be employed at a POS location, according to one embodiment. In an embodiment, a first stage of item scanning may be to calibrate a camera 502, such as an RGB-D camera, or other optical device for each kiosk. As shown in FIG. 6, this may be with state-of-the-art off-the-shelf methods to calibrate an RGB-D camera 602 using a patterned board 604, and known item(s) 606. Once the camera 602 is calibrated, an embodiment may be able to obtain accurate RGB and depth information from items 606 placed in the field of view of the camera 602. FIG. 6 shows an example of item 606 depth-information capture using a LIDAR sensor of the camera 602, and FIG. 7 shows an example of item 700 depth information capture using an RGB-D camera 702.

One embodiment may add permanent calibration indications in the environment that helps the camera 602 in case the camera 602 moves, or anything happens at the kiosk set up. This phase of an embodiment is one where various item information may be captured. In particular, for each item the customer scans, the following pieces of information may be captured and sent to the regional environment: [a] 2D images; [b] video; [c] item depth information, which may be obtained from LiDAR of an RGB-D camera; and [d] inventory data, which may be correlated to a barcode in an existing inventory system and database.

Thus, FIGS. 6 and 7 disclose different respective approaches by way of which one or more embodiments may collect depth information for an item, such as 602 or 700, being scanned. In an embodiment, a single POS may comprise multiple optical devices, each capable of capturing an image of an item. Further, one or more embodiments comprise LiDAR and RGB-D as two examples of approaches for capturing depth information, using depth sensing capabilities in an edge environment.

### B.3 Item Detection

Turning next to FIG. 8, an item detection component 800 of a flow according to one embodiment is disclosed. In an embodiment, the item detection component 800 may intake information captured by an item scanning 802 process, where such information may include, but is not limited to: [a] 2d images; [b] video; [c] item depth information; and [d] barcode identifier. Note that no embodiment is restricted to any particular frame rate, or range of frame rates, with which images, depth and video are captured. In an embodiment, the frame rate may comprise a hyperparameter that can be adjusted if found to be too small or high. In an embodiment, a primary consideration is that the embodiment may be able to capture adequate variety in the poses of the item being held in the camera field of view.

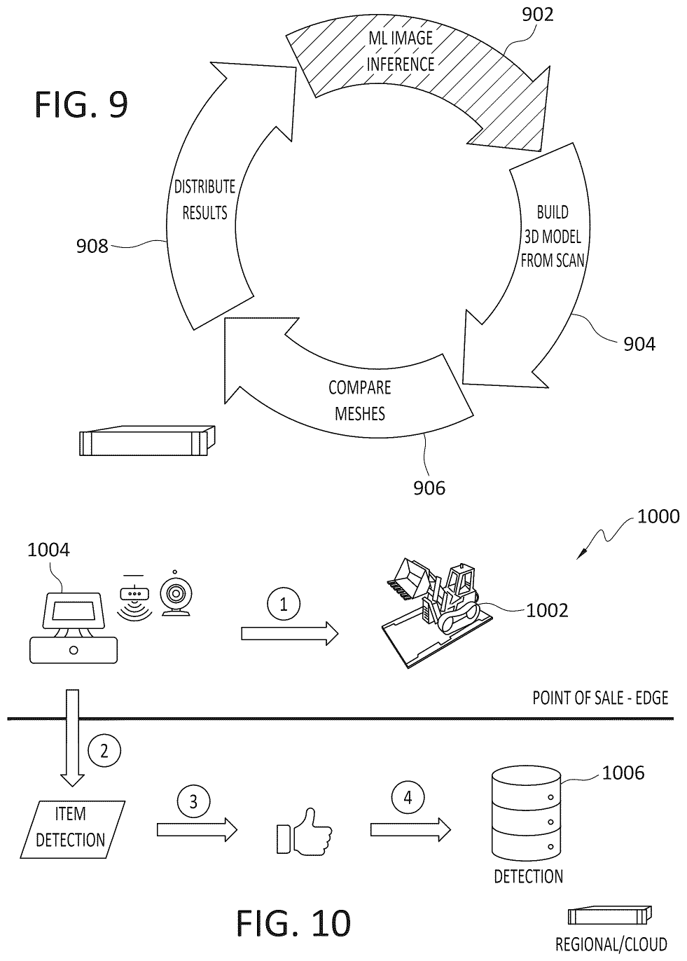

To illustrate, FIG. 9 discloses two possible flows for a given item of interest. The first flow 902 starts and stops at an ML image inference component where an item is confidently identified using 2D images, video, and depth information, without the need to build a 3D model of the item. Alternatively, in one embodiment, a second flow 904, in which a 3D model is built from the scan obtained of an item, may be exercised only if the ML image inference process does not yield a configurable confidence score, that is, a suitably high confidence score indicating an extent to which there is confidence that the inference has correctly identified the item.

With continued reference to the example of FIG. 9, further details are provided concerning the example item detection component 800. In an embodiment, the flow 902, which may be an element of the item detection component 800, may comprise an ML image inference (scoring) process. In an embodiment, probability is an example of a measure that may be used to identify meshes during an item detection phase, and these meshes may later be compared 906. A scoring system according to an embodiment may be configurable such that a score, expressed as a confidence rating, may be derived from feature extraction and similarities discerned from an ML model.

The flow 902 may alternatively comprise an ML image inference (high probability) process. Here, the responsibility of ML image inference is to leverage input from the POS as feature data used to derive a probability of an item match. Feature data may include, but is not limited to: [a] 2D images; [b] depth; and [c] inventory data derived from a barcode. Note that while video is not required as feature data, in an embodiment, 2D images and/or depth information may be extracted from video data that has been collected during an item scan.

Turning next to FIG. 10, there is disclosed an item detection flow 1000, in which the item has a high probability of being a known item. As shown in FIG. 10, when an item 1002, after having been scanned by an optical device 1004, is assigned a high-probability of being a known item, the feature data may be used for the inference, and fed back into the dataset loop where the feature data is persisted and used in subsequent analysis. In particular, the item 1002 may be scanned (1) and the feature data fed (2) to a dataset loop and a determination (3) made that there is a high probability of the item being known, after which the feature data may be persisted (4) to a dataset 1006.

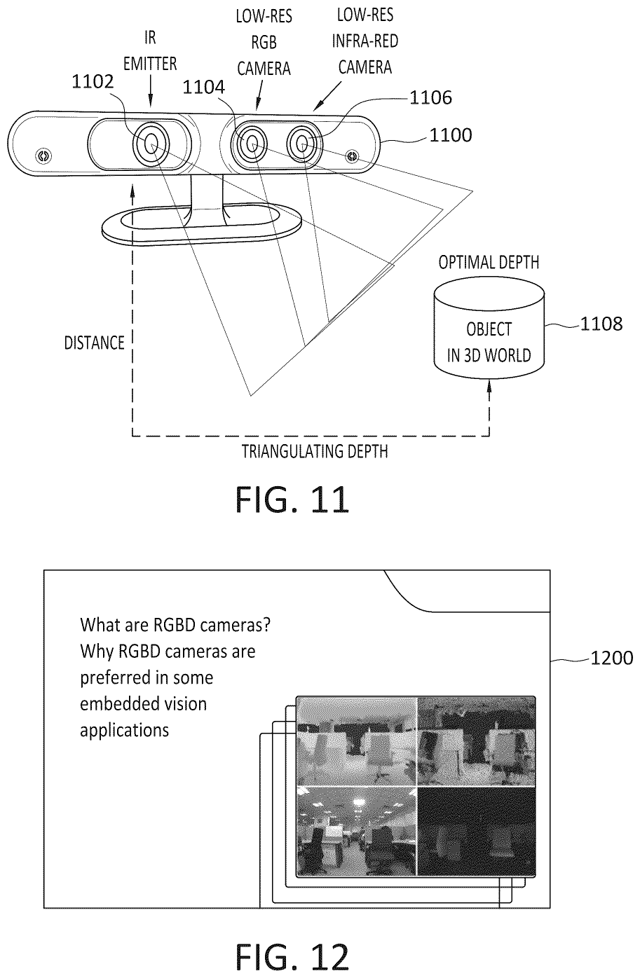

With reference again to the ML image inference (low probability) stage 902 of FIG. 9, the stages 904, 906, and 908, may, in an embodiment, only be exercised if the ML image inference state 902 does not confidently identify an item from the images obtained during the scan performed at the POS. In this case, the data received as output from the item scanning phase imaging and depth sensing process may be used to produce a 3D model. An example of this approach is shown in FIG. 11.

In particular, FIG. 11 discloses an optical system 1100, such as an RGB-D camera, that may comprise an IR (infrared) emitter 1102, a low-resolution RGB camera 1104, and a low-resolution IR camera 1106. As shown, the optical system 1100 may operate to scan an object 1108 to capture 3D model data, that is, data that may be used to create a 3D model of the object 1108. In the example of FIG. 11, the IR emitter 1102 may illuminate the object 1108, and light reflected by the object 1108 may be captured by the low-resolution RGB camera 1104 and/or by the low-resolution IR camera 1106. FIG. 12 discloses an example 1200 of the use of an RGB-D camera for 3D modeling of an object.

### B.4 3D Models and Meshes

An embodiment may generate two different 3D models. As described above, the first model may be the 3D model captured during the inventory 3D modeling phase. In an embodiment, this first model may be a NeRF-based model (neural radiance field neural network). The second model may be the 3D model generated based on imaging and depth information extracted as part of an object scanning process.

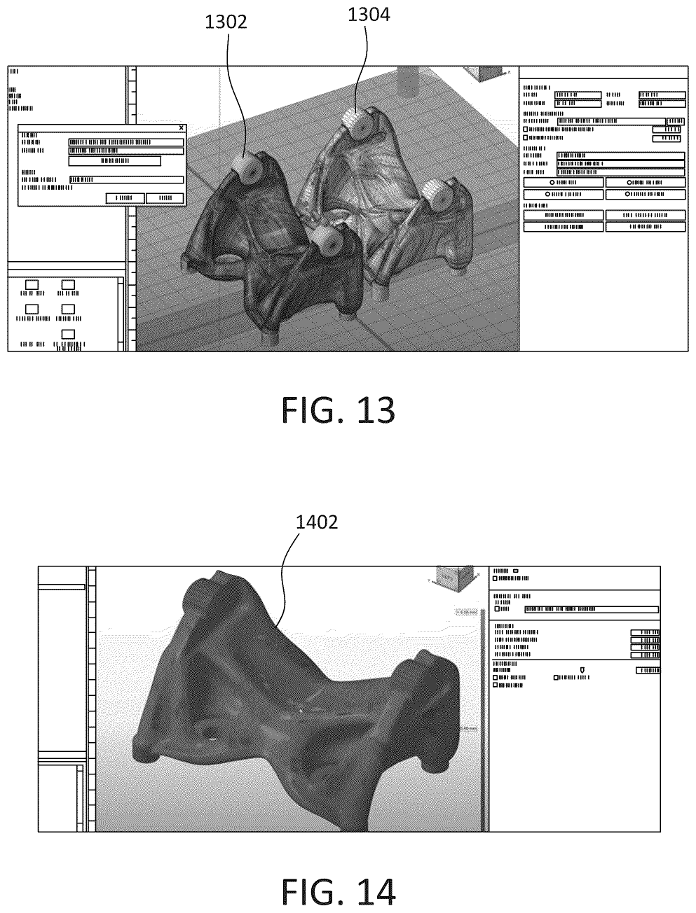

As shown in FIG. 13, the respective meshes of the two different 3D models may be compared (see also, reference 906 in FIG. 9). In FIG. 13, a mesh 1302 represents the 3D model captured during the inventory 3D modeling phase. The mesh 1304 represents the 3D model generated based on data obtained as part of an object scanning process. The two meshes 1302 and 1304 may be compared to each other in any suitable way, such as programmatically or manually, such the difference between the two meshes may be measured. Example processes for performing mesh comparisons are disclosed in the “Autodesk Mesh Comparison (https://help.autodesk.com/view/NETF/2021/ENU/?guid=GUID-92954AFB-ED8D-41A2-928B-B55C4B4C32AA),” and in the “NetFabb Video 3D Mesh Comparison,” both of which are incorporated herein in their respective entireties by this reference.

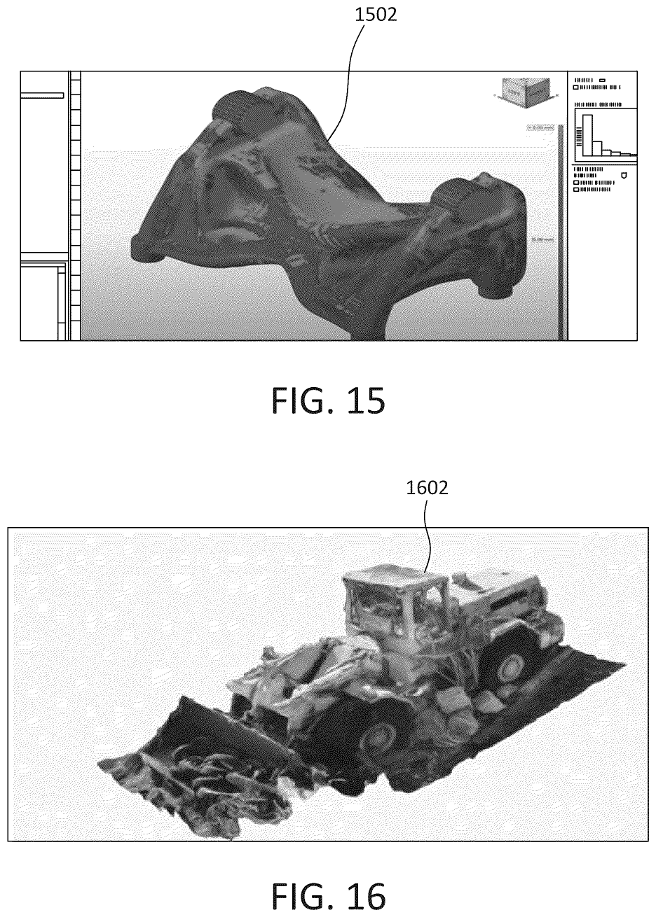

FIG. 14 discloses an example of a higher tolerance mesh 1402 (reflected by the green color-see the Appendix hereto), in terms of difference/comparison between two meshes. FIG. 15 discloses a lower tolerance mesh 1502 (reflected by the red color-see the Appendix hereto), in terms of difference/comparison between two meshes. The aforementioned Appendix forms a part of this disclosure and is incorporated herein in its entirety by this reference.

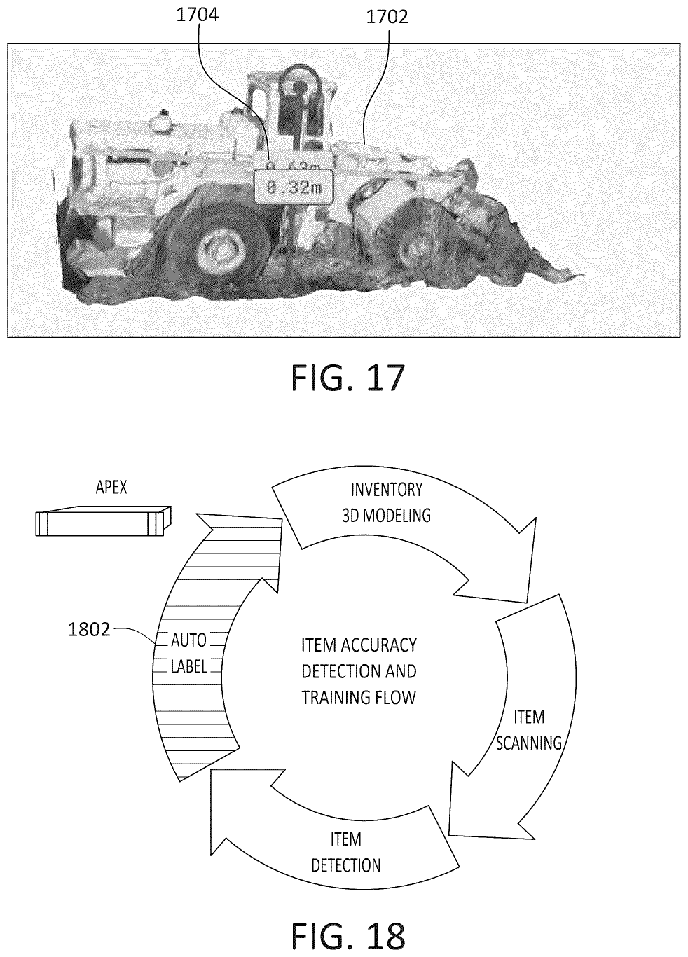

Referring again to FIG. 9, using output from the mesh comparison 906, various perform follow-up actions may be performed. Such actions may include, for example, manual evaluation of an object, such as through use of a dashboard, or flagging a POS transaction for store clerk intervention. Examples of follow-up evaluation, based on a mesh comparison, are respectively disclosed in FIGS. 16 and 17. In general, and as shown in these Figures, a user may be able to rotate a mesh and measure depth from the 3D model generated by an object scanning process. Particularly, FIG. 16 discloses a manual evaluation of an object 1602 performed using a user dashboard, and FIG. 17 discloses a manual evaluation of an object 1702 depth measurement 1704 using a user dashboard.

### B.5 Item/Object Auto Labeling

FIG. 18 discloses an item auto label system component 1802. After a mesh comparison is completed and any information data is derived, any new data may be automatically labelled. This new data may be fed to an ML model for leveraging as a training dataset in effort to help facilitate future comparison and verification.

### C. Further Discussion

As will be apparent from this disclosure, one or more embodiments may possess various useful features and aspects. However, no embodiment is required to implement or possess any of such features and aspects.

As disclosed herein, an embodiment may generate auto-labeled data of fraudulent/inaccurate shelf checkout point-of-sale transactions. By leveraging existing technology in point-of-sale solutions, an embodiment may provide a data-capture to a potential consumer in terms of inventory detection, as well as accurate item scanning. Thus, an embodiment may effectively address a major issue in the retail industry which may become increasingly important as self-checkout kiosks are widely adopted. While the push to a faster experience for the shopper is enabled by self-checkout kiosks, the associated costs, such as in terms of shrinkage and the corresponding financial loss, may be addressed through the implementation of an embodiment.

One embodiment may employ the concept of applying a rigidity index to each item. This rigidity index may enable 3D mesh comparison tolerance per item for a single 3D mesh comparison algorithm. For example, a foam basketball affected by gravity could make comparison difficult as compared to a conventional basketball. That is, the conventional basketball may be less affected by gravity than the foam basketball, and this fact may be used by an embodiment to distinguish between the two different items. Using the rigidity index, an embodiment may maintain a consistent, yet robust comparison algorithm. Thus, through the use of 3D modelling and comparison techniques disclosed herein, an embodiment may improve the accuracy of item scanning as well as minimize the amount of shrinkage experienced at retail stores resulting from fraudulent and/or inaccurate scanning.

Following are some further examples of features and aspects of one or more embodiments. One such aspect concerns self-checkout fraud detection through 3D modeling. Using 2D images or video, and depth sensing equipment, an embodiment may be able to identify inaccurate transactions taking place at self-checkout kiosk through 3D modeling and machine learning techniques. Another aspect relates to Self-Checkout scanning accuracy through auto-labelling scanning data. Particularly, using 2D images or video, and depth sensing equipment, an embodiment may provide a mechanism for retailers to collect physical item data using 3D modeling and machine learning techniques. Conventional approaches leverage metadata for inventory items from barcodes that are scanned. In contrast, an embodiment solution may operate to obtain more information specific to the actual item leaving the store.

Still a further aspect of an embodiment concerns on demand data for use in producing a digital twin representation of an environment. Particularly, an embodiment may operate to create on-demand digital twin environments that provide data enhancing an object detection model.

Another example aspect relates to richer historical transaction data. Specifically, an embodiment may generate insights that can help retailers identify items with high fraudulent frequencies. These insights may, in turn, enable the retailer to take actions to increase security measures for those items, and thereby reduce shrinkage.

Finally, an aspect of an embodiment concerns adaptable 3D mesh comparison tolerance. In particular, an embodiment may consider the rigidity of items when comparing them through the 3D mesh comparison algorithm. Softer classified items may be compared with a lot using looser tolerances.

### D. Example Methods

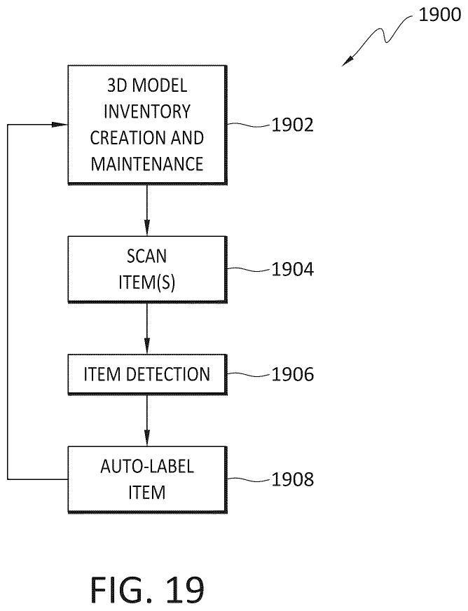

It is noted with respect to the disclosed methods, including the example method of FIG. 19, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 19, a method according to one embodiment is identified with reference 1900. The method 1900 may begin with the creation and/or maintenance 1902 of a 3D model inventory which may contain 3D models for each item of the product inventory of a company. The maintenance of the 3D model may be performed on an ongoing basis as new/modified items are scanned, items are removed from the product inventory, and/or as a result of other events.

Item scanning 1904 may be performed by customers at POS self-service kiosks. Information obtained from the item scanning 1904 may be automatically uploaded from the POS to a regional environment for item identification. In an embodiment, the information may be stored locally at the business enterprise as well.

At the regional environment, the information obtained from the item scanning process 1904 may be evaluated. Based on this evaluation, the item that was scanned may be identified, or detected 1906. The evaluation may involve the use of an ML model to perform an inferencing process to identify the item and/or the evaluation may involve the use of a 3D model that can be compared with the scanning information to identify, with a level of confidence, the item that was scanned.

Finally, after the scanned item has been identified, or detected, at 1906, the information obtained during the scanning process may be labeled 1908 to associate that information with that item. As shown in FIG. 19, the method may be performed recursively and, as such, may return to 1902 after the labeling process 1908 has been performed.

### E. Further Example Embodiments

Following are some further example embodiments of the invention. These are presented only by way of example and are not intended to limit the scope of the invention in any way.
Embodiment 1. A method, comprising: scanning, at a point of sale (POS) site, a physical object; transmitting, from the POS site to a regional environment, information obtained as a result of the scanning of the physical object; identifying the physical object based on the information; automatically labeling any new data generated as a result of the identifying of the physical object; and storing the new data.
Embodiment 2. The method as recited in any preceding embodiment, wherein the physical object is scanned using an RGB-D camera.
Embodiment 3. The method as recited in any preceding embodiment, wherein the POS site is an edge site in an edge network.
Embodiment 4. The method as recited in any preceding embodiment, wherein the information obtained as a result of the scanning comprises any one or more of two-dimensional images, video, item depth information, and inventory data.
Embodiment 5. The method as recited in any preceding embodiment, wherein identifying the physical object is performed with an inferencing process of a machine learning model, and the physical object is only considered as having been identified when a probability that the inferencing process has correctly identified the physical object meets or exceeds a confidence level.
Embodiment 6. The method as recited in any preceding embodiment, wherein the identifying of the physical object is performed based on a three dimensional model of the physical object, and the three dimensional model is constructed based on the information obtained as a result of the scanning process.
Embodiment 7. The method as recited in any preceding embodiment, wherein a mesh comparison process is used to determine which of two three-dimensional models will be used to identify the physical object.
Embodiment 8. The method as recited in embodiment 7, wherein a first one of the three dimensional models is captured during an inventory three dimensional modeling phase, and the second one of the three dimensional models is based on the information obtained from the scanning process, and the first one and the second one of the three dimensional models are each associated with a respective mesh that are compared with each other as part of the mesh comparison process.
Embodiment 9. The method as recited in any preceding embodiment, wherein the information obtained from the scanning process is used to determine whether a fraudulent transaction has occurred at the POS.
Embodiment 10. The method as recited in any preceding embodiment, wherein the POS site is a self-checkout kiosk.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

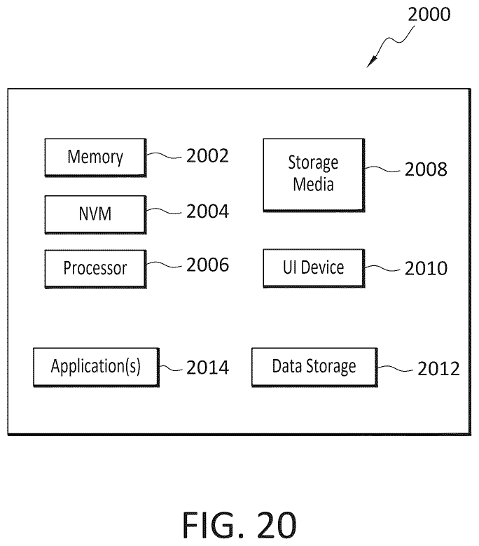

With reference briefly now to FIG. 20, any one or more of the entities disclosed, or implied, by FIGS. 1-19, and/or elsewhere herein, may take the form of, or include, or be implemented on, or hosted by, a physical computing device, one example of which is denoted at 2000. As well, where any of the aforementioned elements comprise or consist of a virtual machine (VM), that VM may constitute a virtualization of any combination of the physical components disclosed in FIG. 20.

In the example of FIG. 20, the physical computing device 2000 includes a memory 2002 which may include one, some, or all, of random access memory (RAM), non-volatile memory (NVM) 2004 such as NVRAM for example, read-only memory (ROM), and persistent memory, one or more hardware processors 2006, non-transitory storage media 2008, UI device 2010, and data storage 2012. One or more of the memory components 2002 of the physical computing device 2000 may take the form of solid state device (SSD) storage. As well, one or more applications 2014 may be provided that comprise instructions executable by one or more hardware processors 2006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
scanning, at a point of sale (POS) site, a physical object;
transmitting, from the POS site to a regional environment, information obtained as a result of the scanning of the physical object;
identifying the physical object based on the information;
automatically labeling any new data generated as a result of the identifying of the physical object; and
storing the new data.

2. The method as recited in claim 1, wherein the physical object is scanned using an RGB-D camera.

3. The method as recited in claim 1, wherein the POS site is an edge site in an edge network.

4. The method as recited in claim 1, wherein the information obtained as a result of the scanning comprises any one or more of two-dimensional images, video, item depth information, and inventory data.

5. The method as recited in claim 1, wherein identifying the physical object is performed with an inferencing process of a machine learning model, and the physical object is only considered as having been identified when a probability that the inferencing process has correctly identified the physical object meets or exceeds a confidence level.

6. The method as recited in claim 1, wherein the identifying of the physical object is performed based on a three dimensional model of the physical object, and the three dimensional model is constructed based on the information obtained as a result of the scanning process.

7. The method as recited in claim 1, wherein a mesh comparison process is used to determine which of two three-dimensional models will be used to identify the physical object.

8. The method as recited in claim 7, wherein a first one of the three dimensional models is captured during an inventory three dimensional modeling phase, and the second one of the three dimensional models is based on the information obtained from the scanning process, and the first one and the second one of the three dimensional models are each associated with a respective mesh that are compared with each other as part of the mesh comparison process.

9. The method as recited in claim 1, wherein the information obtained from the scanning process is used to determine whether a fraudulent transaction has occurred at the POS.

10. The method as recited in claim 1, wherein the POS site is a self-checkout kiosk.

11. A non-transitory storage medium having stored therein instructions that are executable by one or more hardware processors to perform operations comprising:
scanning, at a point of sale (POS) site, a physical object;
transmitting, from the POS site to a regional environment, information obtained as a result of the scanning of the physical object;
identifying the physical object based on the information;
automatically labeling any new data generated as a result of the identifying of the physical object; and
storing the new data.

12. The non-transitory storage medium as recited in claim 11, wherein the physical object is scanned using an RGB-D camera.

13. The non-transitory storage medium as recited in claim 11, wherein the POS site is an edge site in an edge network.

14. The non-transitory storage medium as recited in claim 11, wherein the information obtained as a result of the scanning comprises any one or more of two-dimensional images, video, item depth information, and inventory data.

15. The non-transitory storage medium as recited in claim 11, wherein identifying the physical object is performed with an inferencing process of a machine learning model, and the physical object is only considered as having been identified when a probability that the inferencing process has correctly identified the physical object meets or exceeds a confidence level.

16. The non-transitory storage medium as recited in claim 11, wherein the identifying of the physical object is performed based on a three dimensional model of the physical object, and the three dimensional model is constructed based on the information obtained as a result of the scanning process.

17. The non-transitory storage medium as recited in claim 11, wherein a mesh comparison process is used to determine which of two three-dimensional models will be used to identify the physical object.

18. The non-transitory storage medium as recited in claim 17, wherein a first one of the three dimensional models is captured during an inventory three dimensional modeling phase, and the second one of the three dimensional models is based on the information obtained from the scanning process, and the first one and the second one of the three dimensional models are each associated with a respective mesh that are compared with each other as part of the mesh comparison process.

19. The non-transitory storage medium as recited in claim 11, wherein the information obtained from the scanning process is used to determine whether a fraudulent transaction has occurred at the POS.

20. The non-transitory storage medium as recited in claim 11, wherein the POS site is a self-checkout kiosk.
